(19) United States
(12) Patent Application Publication
(10) Pub. No.: US 2012/0251265 A1
(43) Pub. Date: Oct. 4, 2012

(54) FLOATING CAPTIVE SCREW

(76) Inventor: Ming-Chung CHIU, New Taipei City (TW)

(21) Appl. No.: 13/079,500

(22) Filed: Apr. 4, 2011

(51) Int. Cl. F16B 41/00

(52) U.S. Cl. 411/349

(57) ABSTRACT

A floating captive screw includes a mounting socket having a top orifice, an upper flange extending around the periphery and a bottom mounting portion for bonding to a first metal plate member, a locking screw bolt inserted through the mounting socket for fastening to a second metal plate member to lock the first metal plate member to the second metal plate member and having a shoulder for engaging into the top orifice to temporarily lock the locking screw bolt to the mounting socket, a spring member stopped between the head of the locking screw bolt and the upper flange of the mounting socket to impart an upward pressure to the locking screw bolt, and a cap member affixed to the head of the locking screw bolt and axially slidably coupled to the periphery of the mounting socket and stoppable at the bottom side of the upper flange of the mounting socket.

### BACKGROUND OF THE INVENTION

1. Field of the Invention

The present invention relates to fasteners for joining metal plate members and more particularly, to a floating captive screw consisting of a mounting socket, a locking screw bolt, and spring member and a cap member wherein the locking screw bolt has a shoulder detachably engageable into a top orifice of the mounting socket to temporarily lock the locking screw bolt to the mounting socket for enabling the mounting socket to be bonded to a metal plate member accurately and rapidly.

2. Description of the Related Art

When fastening plate members together, positioning screws that are each formed of a knob, a ring and a screw nail are usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together. The power drive and speed-adjustment unit of a machine tool are generally provided inside the housing. However, during a mounting or dismounting operation, the screw nails may be lost accidentally, causing installation problems.

To facilitate detachable installation and to avoid missing component parts, floating captive screws are created. FIG. 10 illustrates a floating captive screw according to the prior art. According to this design, the floating captive screw comprises a mounting socket A, a locking screw B floating in the mounting socket A, a spring member A1 sleeved onto the locking screw B and stopped between a mounting flange A2 around the periphery of the mounting socket A and a head B1 of the locking screw B, a stop member A3 mounted inside the mounting socket A, and a screw nut C threaded onto a threaded shank B2 of the locking screw B after insertion of the threaded shank B2 of the locking screw B through the stop member A3 and a inside chamber A0 of the mounting socket A. Further, the mounting socket A has a bottom bonding end A4 for bonding to a plate member D.

This design of floating captive screw is still not satisfactory in function, and has drawbacks. The locking screw B is supported on the spring member A1 and floating in the mounting socket A. When bonding the bottom bonding end A4 of the mounting socket A to the plate member D, the locking screw B may vibrate to interfere with the bonding operation, and the mounting socket A may be not bonded to the plate member D accurately in position, affecting further installation of the screw nut C. Further, when bonding the bottom bonding end A4 of the mounting socket A to the plate member D, the melted solder paste may flow through the gap in between the mounting socket A and the plate member D to the screw nut C. When this problem occurs, the screw nut C will be stuck in the floating captive screw. In this case, the operator will be difficult to remove the screw nut C from the locking screw B, wasting much time and labor and increasing the installation cost.

Therefore, it is desirable to provide a floating captive screw that eliminates the drawbacks of the aforesaid prior art design.

### SUMMARY OF THE INVENTION

The present invention has been accomplished under the circumstances in view. It is therefore an object of the present invention to provide a floating captive screw, which prohibits the locking screw bolt thereof from floating when bonding the mounting socket thereof to a predetermined metal plate member, facilitating installation.

To achieve this and other objects of the present invention, a floating captive screw is provided for bonding to a first metal plate member for detachably fastening said first metal plate member to a second metal plate member. The floating captive screw comprises a mounting socket, a locking screw bolt, a spring member supporting the locking screw bolt in the mounting socket and a cap member affixed to the periphery of the head of the locking screw bolt. The mounting socket comprises an open chamber cut through opposing top and bottom sides thereof and a top orifice defined in the top side of the open chamber. The locking screw bolt is inserted through the top orifice and the open chamber, having a shoulder detachably engageable into the top orifice of the mounting socket to lock the locking screw bolt to the mounting socket and to prohibit the locking screw bolt from biasing relative to the mounting socket for enabling the mounting socket to be bonded to a metal plate member accurately and rapidly.

Further, the shoulder of the locking screw bolt comprises a plurality of retaining grooves located on the periphery thereof to facilitate engagement of the shoulder of the locking screw bolt with the top orifice of the mounting socket.

### BRIEF DESCRIPTION OF THE DRAWINGS

FIG. 1 is an oblique top elevation of a floating captive screw in accordance with the present invention.

FIG. 2 is an exploded view of the floating captive screw in accordance with the present invention.

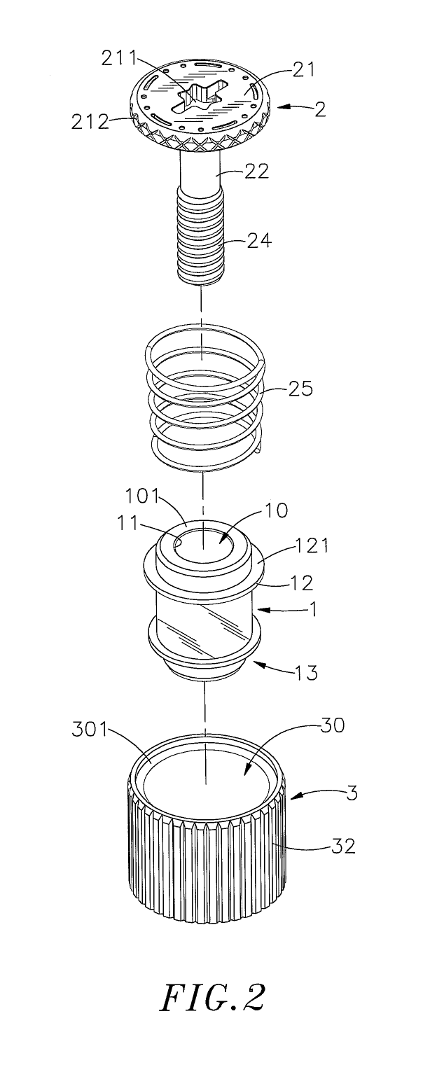

FIG. 3 is a sectional side view of FIG. 2.

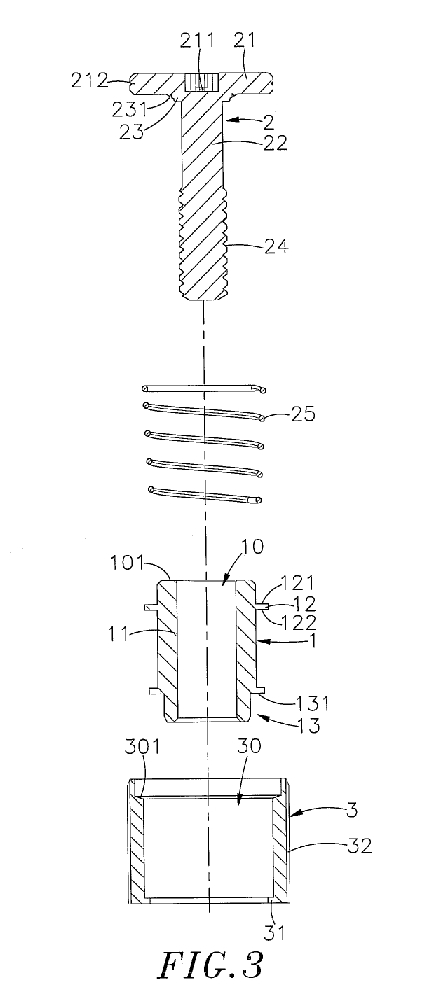

FIG. 4 is a sectional assembly view of the present invention, illustrating the assembly process of the floating captive screw in a pressure mold (I).

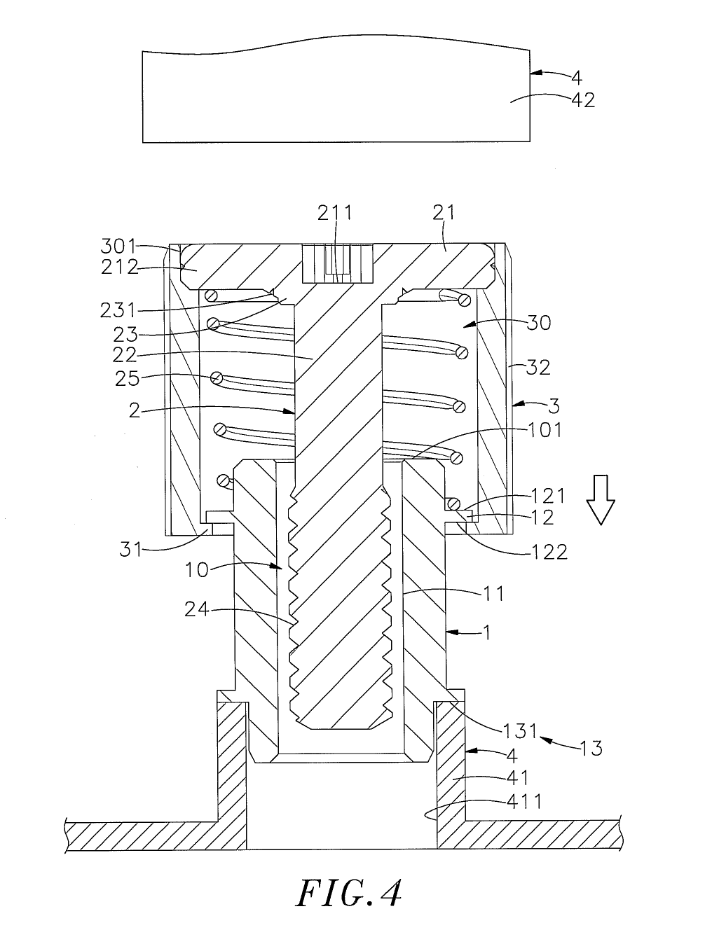

FIG. 5 is a sectional assembly view of the present invention, illustrating the assembly process of the floating captive screw in a pressure mold (II).

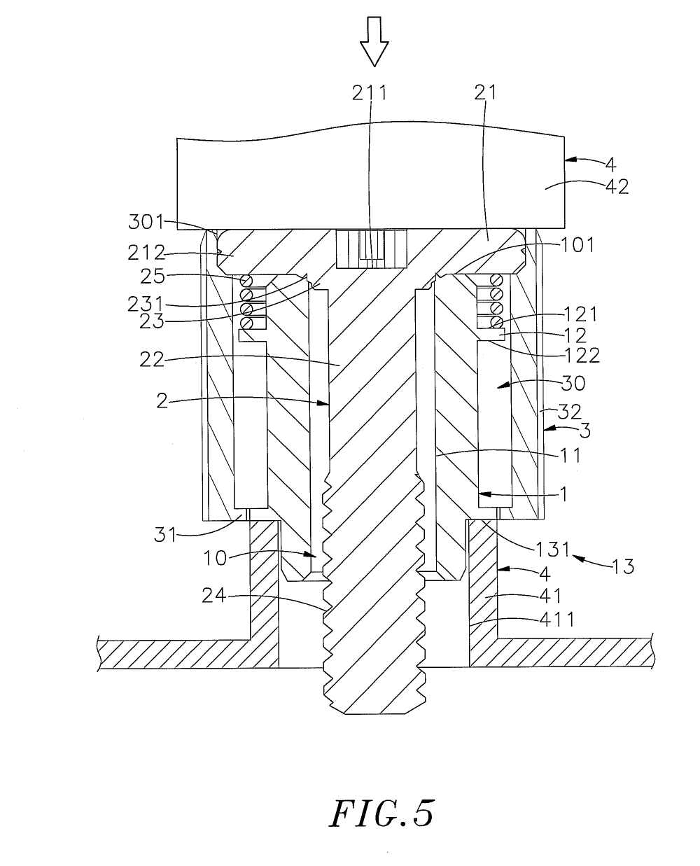

FIG. 6 is a schematic sectional view of the present invention, illustrating the floating captive screw carried by a suction device to a metal plate member for installation.

FIG. 7 is a schematic sectional view of the present invention, illustrating the floating captive screw bonded to the metal plate member.

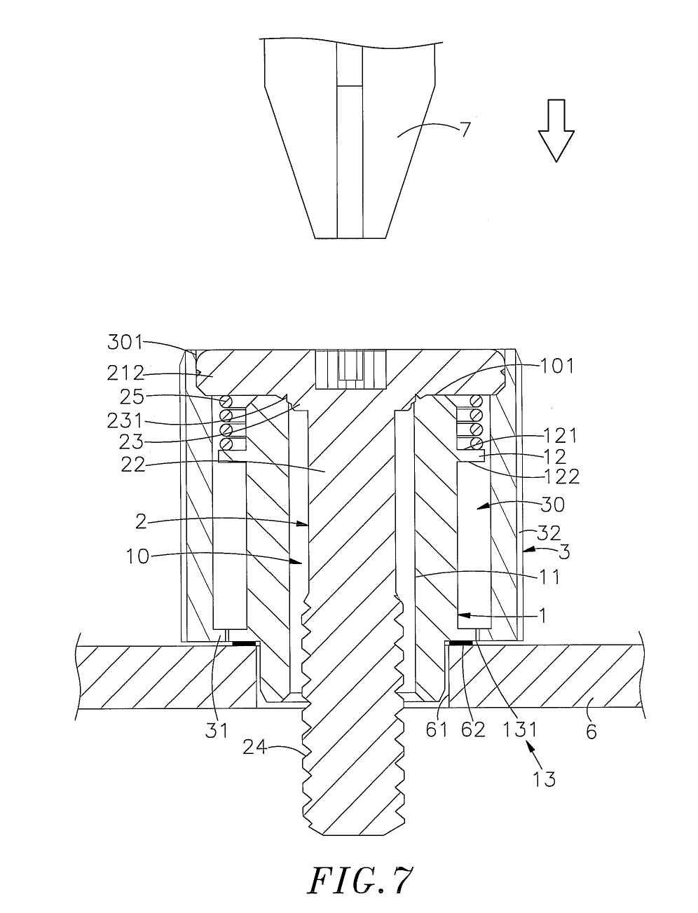

FIG. 8 is a schematic sectional view of the present invention, illustrating the shoulder of the locking screw bolt disengaged from the top orifice of the mounting socket before attachment of the metal plate member to a mating metal plate member.

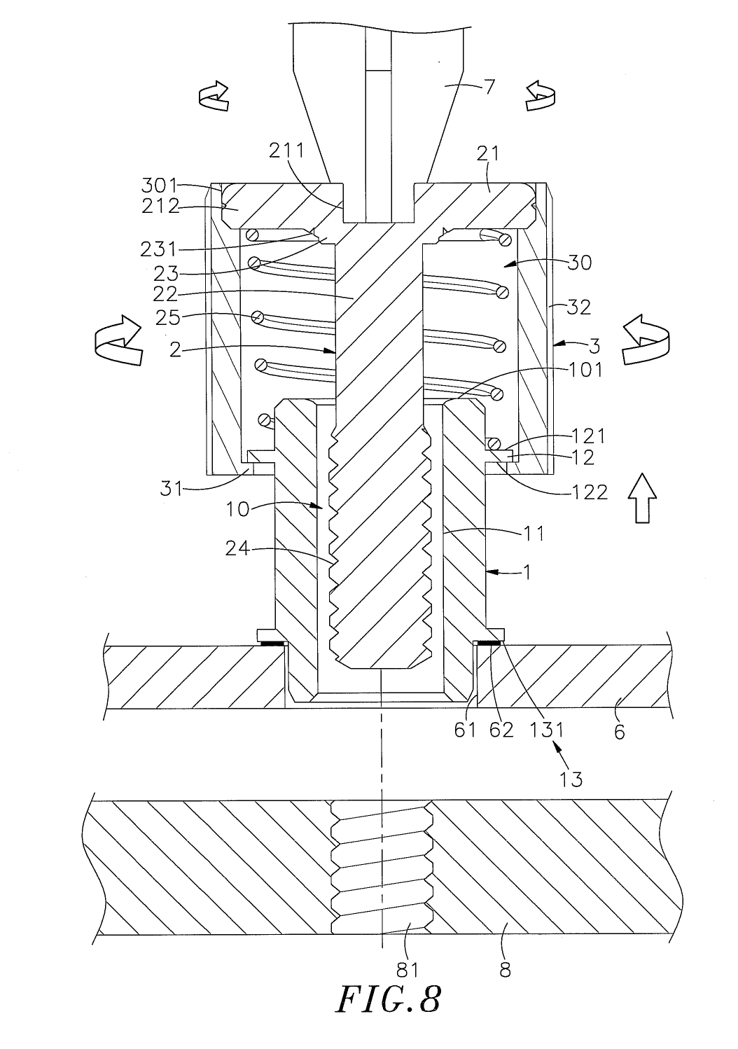

FIG. 9 corresponds to FIG. 8, illustrating the metal plate member attached to the mating metal plate member and the locking screw bolt driven into the mounting screw hole of the mating metal plate member.

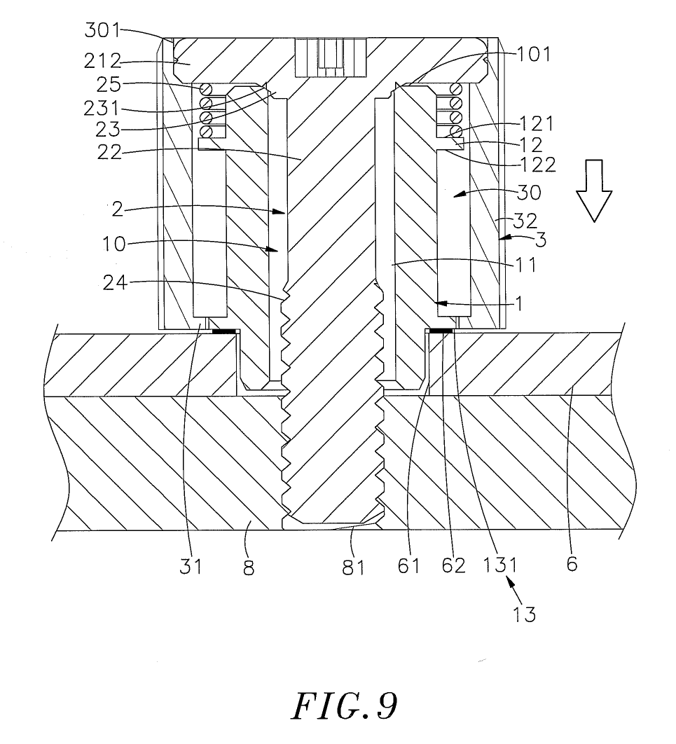

FIG. 10 is a schematic sectional view of a floating captive screw according to the prior art.

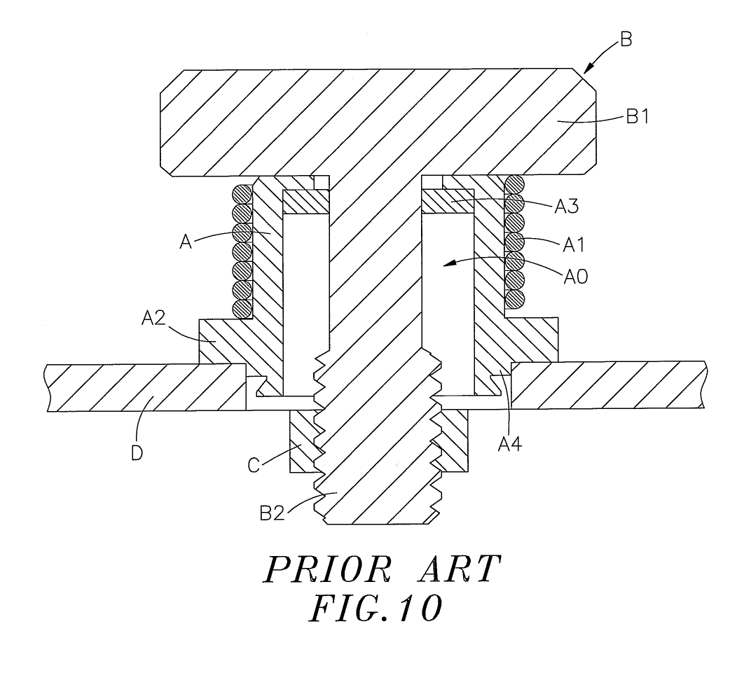

### DETAILED DESCRIPTION OF THE PREFERRED EMBODIMENT

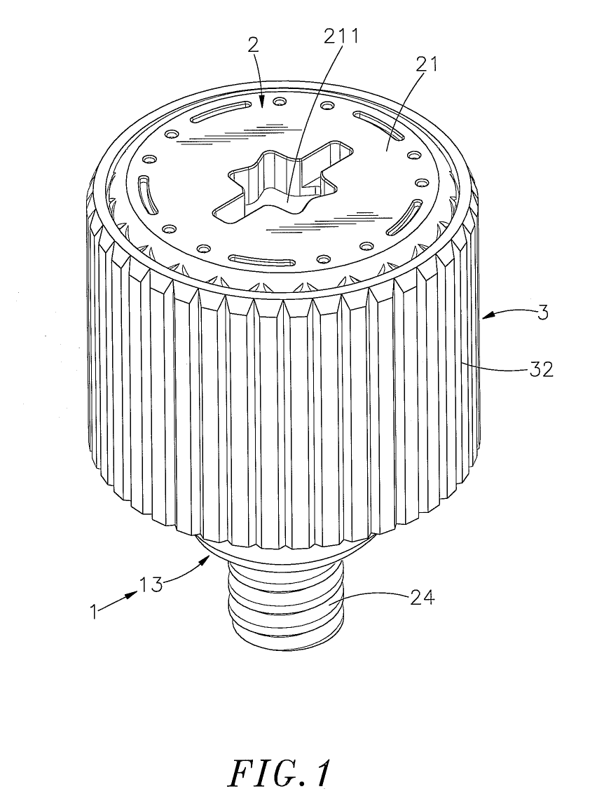

Referring to FIGS. 1˜5, a floating captive screw in accordance with the present invention is shown comprising a mounting socket 1, a locking screw bolt 2, a spring member 25 and a cap member 3.

The mounting socket 1 comprises an open chamber 10 cut through opposing top and bottom sides thereof and defining a top orifice 11 in a top side 101, an upper flange 12 extending around the periphery near the top side and defining a flat top bearing surface 121 and a flat bottom stop surface 122, and a bottom mounting portion 13 located on the bottom side and defining a horizontally extending bonding face 131.

The locking screw bolt 2 comprises a head 21, a tool-driving device 211 located on the top wall of the head 21, a shank 22 perpendicularly extended from the center of the bottom wall of the head 21 and terminating in a threaded fastening end piece 24, an engagement portion 212 located on the periphery of the head 21, and a shoulder 23 connected between the shank 22 and the bottom wall of the head 21. The tool-driving device 211 can be a Phillips groove, keystone groove, asterisk groove, hex groove, or any other design of tool groove for driving by a hand tool. The engagement portion 212 can be formed of a plurality of teeth, barbs or protruding cones. The shoulder 23 has a plurality of retaining grooves 231 located on the periphery thereof. Further, the diameter greater of the shoulder 23 is greater than the shank 22 and the threaded fastening end piece 24.

The spring member 25 is sleeved onto the locking screw bolt 2 and the mounting socket 1 and stopped between the bottom wall of the head 21 of the locking screw bolt 2 and the flat top bearing surface 121 of the upper flange 12 of the mounting socket 1.

The cap member 3 comprises an open space 30 extending through opposing top and bottom sides thereof, a locating groove 301 extending around the inside wall thereof at a top side in the open space 30, an annular inside bottom flange 31 extending around the inside wall thereof at a bottom side in the open space 30 and a grip 32 located on the periphery thereof.

When assembling the component parts of the floating captive screw, insert the shank 22 of the locking screw bolt 2 through the spring member 25 into the open chamber 10 of the mounting socket 1 to let the spring member 25 be compressed between the head 21 of the locking screw bolt 2 and the flat top bearing surface 121 of the upper flange 12 of the mounting socket 1, and then sleeve the cap member 3 upwardly onto the mounting socket 1 to move the annular inside bottom flange 31 over the bottom mounting portion 13 below the upper flange 12, and then cap the cap member 3 onto the head 21 of the locking screw bolt 2 to force the locating groove 301 into engagement with the engagement portion 212 tightly. At this time, the spring member 25 is stopped between the bottom wall of the head 21 of the locking screw bolt 2 and the flat top bearing surface 121 of the upper flange 12 of the mounting socket 1, and the cap member 3 with the locking screw bolt 2 are coupled to the mounting socket 1 in a floating condition. Because the cap member 3 is tightly engaged with the engagement portion 212 of the locking screw bolt 2 and the annular inside bottom flange 31 of the cap member 3 is stopped below the upper flange 12, the locking screw bolt 2 and the spring member 25 will not fall from the mounting socket 1.

Thereafter, insert the bottom mounting portion 13 of the mounting socket 1 into a positioning hole 411 in a mold base 41 of a pressure mold 4 to stop the horizontally extending bonding face 131 of the bottom mounting portion 13 at the topmost edge of the mold base 41, and then stamp a die head 42 of the pressure mold 4 downwardly onto the head 21 of the locking screw bolt 2 to force the shoulder 23 into the top orifice 11 in the top side 101 and to deform the periphery of the top side 101 around the top orifice 11. At this time, the head 21 of the locking screw bolt 2 is temporarily secured to the top side of the mounting socket 1, keeping the retaining grooves 231 of the shoulder 23 in engagement with the periphery of the top orifice 11 of the mounting socket 1. Thus, the floating captive screw is well assembled.

Further, the aforesaid locking screw bolt 2 can be made of aluminum alloy, copper alloy, zinc alloy, or any other suitable metal material. Further, the engagement portion 212 can be formed on the periphery of the head 21 of the locking screw bolt 2 by extrusion, embossing or milling techniques. Alternatively, the cap member 3 can be formed integral with the periphery of the head 21 of the locking screw bolt 2 by using insert-molding technique.

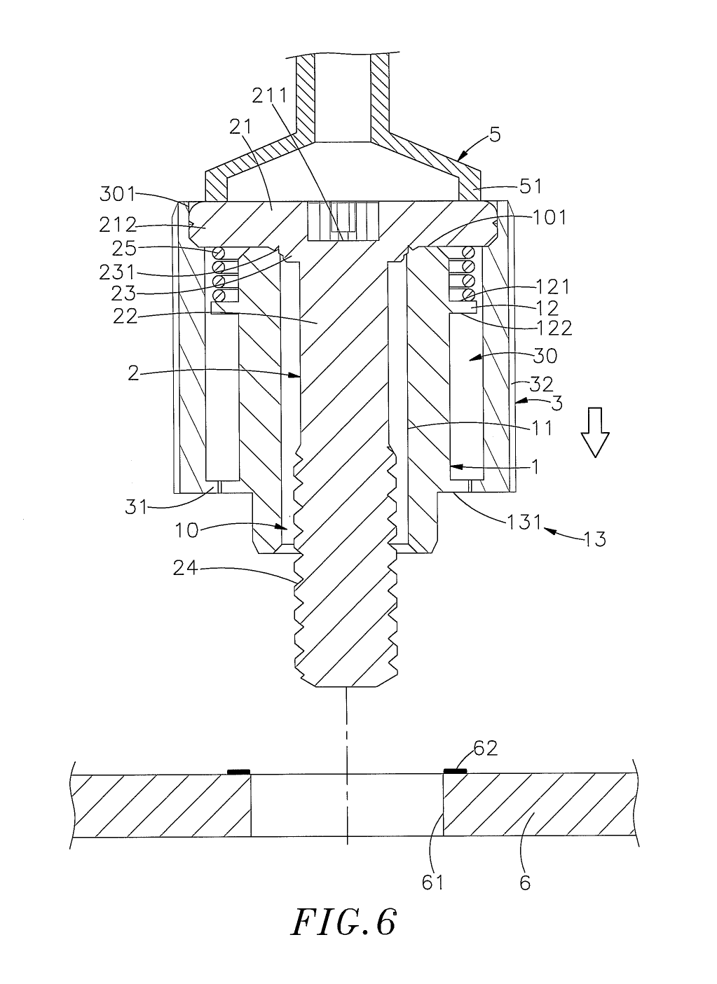

Referring to FIGS. 6˜9, after the floating captive screw is assembled, a vacuum suction device 5 is operated to attach a suction head 51 thereof to a strippable protective film (not shown) of the head 21 of the locking screw bolt 2 and then to pick up the floating captive screw and carry the floating captive screw a position right above a mounting through hole 61 of one metal plate member 6, thereafter the vacuum suction device 5 is operated to release the floating captive screw from the suction head 51, enabling the bottom mounting portion 13 of the mounting socket 1 of the floating captive screw to fall to the mounting through hole 61 of the metal plate member 6. At this time, the move the annular inside bottom flange 31 over the horizontally extending bonding face 131 of the bottom mounting portion 13 of the mounting socket 1 is stopped at a solder paste 62 at the top surface of the metal plate member 6 around the mounting through hole 61, and then a bonding technique (reflow soldering or spot welding technique) is applied to fixedly fasten the mounting socket 1 to the metal plate member 6. As the head 21 of the locking screw bolt 2 is positively rested on the top side 101 of the mounting socket 1 over the top orifice 11 and prohibited from biasing relative to the mounting socket 1, the floating captive screw can be stably picked up by the vacuum suction device 5 and accurately moved to the position right above the mounting through hole 61 of one metal plate member 6. As the locking screw bolt 2 is prohibited from biasing relative to the mounting socket 1, the mounting socket 1 can be bonded to the mounting through hole 61 of one metal plate member 6 accurately and rapidly, assuring a high level of bonding quality and lowering the cost.

After the mounting socket 1 is affixed to the metal plate member 6, use a hand tool (not shown) to rotate the tool-driving device 211 of the head 21 of the locking screw bolt 2 through a certain angle relative to the mounting socket 1 and the metal plate member 6, disengaging the shoulder 23 of the locking screw bolt 2 from the retaining hole 11 of the mounting socket 1 and enabling the locking screw bolt 2 to be pushed upwardly outwards relative to the mounting socket 1 by the spring member 25. Thus, the locking screw bolt 2 is floating in the mounting socket 1, and the annular inside bottom flange 31 of the cap member 3 is movable along the periphery of the mounting socket 1 below the upper flange 12.

After installation of the floating captive screw in the metal plate member 6, the metal plate member 6 can be attached to a mating metal plate member 8 and locked thereto by the floating captive screw. When the metal plate member 6 is attached to the mating metal plate member 8, the locking screw bolt 2 is kept in axial alignment with a mounting screw hole 81 of the mating metal plate member 8. At this time, a power (or manual) hand tool 7 can be attached to the tool-driving device 211 of the head 21 of the locking screw bolt 2 and operated to drive the fastening end piece 24 of the locking screw bolt 2 into the mounting screw hole 81, thereby locking the metal plate member 6 to the mating metal plate member 8.

It is to be understood that the above-described embodiment of the invention is merely a possible example of implementations, merely set forth for a clear understanding of the principles of the invention, many modifications and enhancements may be made without departing from the spirit and scope of the invention. Accordingly, the invention is not to be limited except as by the appended claims.

What the invention claimed is:

1. A floating captive screw mounted in a first metal plate member for detachably fastening said first metal plate member to a second metal plate member, comprising:
a mounting socket comprising an open chamber, an open chamber cut through opposing top and bottom sides thereof and defining a top orifice in the top side, an upper flange extending around the periphery near the top side and defining a flat top bearing surface and a flat bottom stop surface, and a bottom mounting portion located on the bottom side for bonding to a mounting through hole on said first metal plate member;
a locking screw bolt floatable in said mounting socket and adapted for fastening to a mounting screw hole on said second metal plate member to lock said first metal plate member to said second metal plate member, said locking screw bolt comprising a head, a shank perpendicularly downwardly extended from the center of a bottom wall of said head and terminating in a threaded fastening end piece for threading into the mounting screw hole of said second metal plate member and a shoulder connected between said head and said shank and engageable into said top orifice of said mounting socket to temporarily lock said locking screw bolt to said mounting socket;
a spring member sleeved onto said shank of said locking screw bolt and stopped between said head of said locking screw bolt and said upper flange of said mounting socket; and
a cap member affixed to said head of said locking screw bolt and axially slidably coupled to the periphery of said mounting socket, said cap member comprising an open space extending through opposing top and bottom sides thereof and an annular inside bottom flange extending around an inside wall thereof at a bottom side in said open space and slidably coupled to the periphery of said mounting socket and stoppable below said upper flange of said mounting socket.

2. The floating captive screw as claimed in claim 1, wherein said bottom mounting portion of said mounting socket is insertable into the mounting through hole of said first metal plate member, defining a horizontally extending bonding face for bonding to a top wall of said first metal plate member around said mounting through hole.

3. The floating captive screw as claimed in claim 2, wherein the outer diameter of said horizontally extending bonding face of said bottom mounting portion of said mounting socket is smaller than the outer diameter of said upper flange.

4. The floating captive screw as claimed in claim 2, wherein the horizontally extending bonding face of said bottom mounting portion of said mounting socket is bonded to the top wall of said first metal plate member around said mounting through hole with a solder paste.

5. The floating captive screw as claimed in claim 1, wherein said locking screw bolt further comprises a tool-driving device located on a top wall of said head for driving by a hand tool, and an engagement portion located on the periphery of said head; said cap member further comprises a locating groove extending around an inside wall thereof at a top side in said open space and forced into engagement with the engagement portion of said locking screw bolt tightly.

6. The floating captive screw as claimed in claim 1, wherein said shoulder of said locking screw bolt comprises a plurality of retaining grooves located on the periphery thereof and detachably forced into engagement with the top orifice of said mounting socket to prohibit said locking screw bolt from floating in said mounting socket.
